(19) United States
(12) Patent Application Publication
(10) Pub. No.: US 2025/0045783 A1
(43) Pub. Date: Feb. 6, 2025

(54) HISTORICAL DATABASE GENERATION SYSTEM AND METHOD

(71) Applicant: Jodi Elizabeth Schneider-Ceroll, Rancho Mirage, CA (US)

(72) Inventor: Jodi Elizabeth Schneider-Ceroll, Rancho Mirage, CA (US)

(21) Appl. No.: 18/364,584

(22) Filed: Aug. 3, 2023

(51) Int. Cl. G06Q 30/0203

(52) U.S. Cl. CPC G06Q 30/0203

(57) ABSTRACT

A historical database generation system includes a processor, and a memory. The memory stores a plurality of instructions, which, on execution, causes the processor to transmit localization information associated with a first computing device of a first user to a second computing device. The processor is configured to receive a historic fact associated with the localization information based on a historical data set from the second computing device. The second computing device is configured to generate output data on the first computing device. The output data is correlated with the historical data set and the localization information. The output data is associated with the historic fact. The second computing device generates a request for the first user to add a user-supplied historic fact. The first computing device transmits the user-supplied historic fact to the second computing device. The user-supplied historic fact is updated to a historical database.

### BACKGROUND

### Technical Field

The invention presented herein is generally directed toward a historical database generation system. More particularly, a system and method to generate historical data based on a geographical location of a computing device.

### Description of the Related Art

Many travelers visit a place without having a sufficient understanding of its history. Travelers face several issues while traveling to know the history and interesting facts of a specific location. They may face difficulty in understanding and communicating in the local language, which can make it challenging to access historical information or communicate with locals who know the area. Typically, travelers have limited access to reliable information about the history and interesting facts of a specific location, especially if they are visiting a remote or less touristy destination.

Further, travelers may not have enough time to explore and discover the historical and interesting facts of a specific location, especially if they are on a tight schedule. Also, travelers may have difficulty contextualizing the information they receive about a location without understanding the broader historical and cultural background of the area. Travelers may face cultural differences that affect their ability to understand and appreciate the history and interesting facts of a specific location, such as differences in customs, traditions, and beliefs.

A lack of historical knowledge can be problematic because history plays an important role in shaping the cultural identity of a place, and can provide valuable insights into its people, traditions, and way of life.

When travelers visit a new place without any prior knowledge of its history, they may miss out on important cultural and historical landmarks, events, and experiences that can enrich their travel experience. They may also fail to appreciate the significance of certain cultural practices or customs and may be less likely to engage with the local community in a meaningful way.

Moreover, the lack of historical knowledge can lead to misunderstandings and misinterpretations of cultural practices, which can be disrespectful or offensive to the local community. For example, a tourist who is unaware of the cultural significance of a particular monument or religious site may behave inappropriately or disrespectfully, offending the local people.

In some cases, the lack of historical knowledge may also result in missed opportunities for economic or cultural development. For instance, a town with a rich cultural heritage may fail to attract tourists or investment because of a lack of awareness or promotion of its historical significance.

Thus, the problem of being unaware of the history of a place can have negative consequences for both travelers and the local community. Therefore, there is a need for a historical database generation system and method to enhance the travel experience and generate historical data based on the geographical location of computing devices of travelers.

Thus, in view of the above, there is a long-felt need in the industry to address the aforementioned deficiencies and inadequacies.

It is with respect to these and other considerations that the disclosure made herein is presented.

### SUMMARY

A historical database generation system to generate historical data based on a geographical location of a computing device is provided, as shown in and/or described in connection with at least one of the figures.

One aspect of the present disclosure relates to a historical database generation system that includes a processor, and a memory. The memory is communicatively coupled to the processor, wherein the memory stores a plurality of instructions, which, on execution, causes the processor to: transmit, to a second computing device, localization information associated with a first computing device of a first user; receive, from the second computing device, based on a historical data set, a historic fact associated with the localization information; generate, by the second computing device, an output data on the first computing device, wherein the output data is correlated with the historical data set and the localization information, wherein the output data is associated with the historic fact; generate, by the second computing device, a request for the first user to add a user-supplied historic fact; and transmit, by the first computing device, the user-supplied historic fact to the second computing device. The user-supplied historic fact is updated to a historical database.

In an aspect, the processor is configured to determine, based on the localization information of the first computing device, a history provider localized within a threshold distance from the first computing device. The processor is configured to determine, based on a questionnaire comprising one or more preferences of the history provider, that the history provider provides one or more scheduled interviews. The processor is configured to transmit, to the first computing device, information associated with the history provider, and a scheduling request link is configured to notify the history provider of an interview request submitted by the first user.

In an aspect, the processor is configured to store and generate the historical data set in a plurality of formats comprising an audio format, a video format, and a textual format.

In an aspect, the first computing device comprises a Global Positioning System (GPS) mechanism to provide the localization information of the first user.

In an aspect, the second computing device is a cloud-based server.

In an aspect, the processor is configured to facilitate the history provider to create a questionnaire related to the historical data set, wherein the cloud-based server is configured to store the questionnaire.

In an aspect, the processor is configured to facilitate the first user to select a year to retrieve the historic fact for that year.

Another aspect of the present disclosure relates to an application server that includes a processor, and a memory. The memory is communicatively coupled to the processor, wherein the memory stores processor instructions, which, on execution, causes the processor to receive localization information associated with a first computing device indicative of a location of a first user. The processor is configured to receive a historical data set. The processor is configured to correlate the localization information of the first user with the historical data set to generate output data. The output data is associated with the historic fact. The processor is configured to transmit the historic fact to the first computing device. The processor is configured to receive, by a second computing device, a user-supplied historic fact from the first user. The processor is configured to update the user-supplied historic fact in a historical database.

In an aspect, the processor is configured to determine, based on the localization information of the first computing device, a history provider localized within a threshold distance from the first computing device.

In an aspect, the processor is configured to determine, based on a questionnaire comprising one or more preferences of the history provider, that the history provider provides one or more scheduled interviews.

In an aspect, the processor is configured to transmit, to the first computing device, information associated with the history provider and a scheduling request link configured to notify the history provider of an interview request submitted by the first user.

In an aspect, the processor is configured to store and generate the historical data set in a plurality of formats comprising an audio format, a video format, and a textual format.

In an aspect, the first computing device comprises a Global Positioning System (GPS) mechanism to provide the localization information of the first user.

Another aspect of the present disclosure relates to a historical database generation method. The method initiates with a step of receiving, by a processor, localization information associated with a first computing device indicative of a location of a first user. The method includes a step of receiving, by the processor, a historical data set. The method includes a step of correlating, by the processor, the localization information of the first user with the historical data set to generate output data. The output data is associated with the historic fact. The method includes a step of transmitting, by the processor, the historic fact to the first computing device. The method includes a step of receiving, by a second computing device, a user-supplied historic fact from the first user. The method includes a step of updating, by the processor, the user-supplied historic fact in a historical database.

In an aspect, the historical database generation method includes a step of determining, by the processor, based on the localization information of the first computing device, a history provider localized within a threshold distance from the first computing device.

In an aspect, the historical database generation method includes a step of determining, by the processor, based on a questionnaire comprising one or more preferences of the history provider, that the history provider provides one or more scheduled interviews.

In an aspect, the historical database generation method includes a step of transmitting, by the processor, to the first computing device, information associated with the history provider, and a scheduling request link configured to notify the history provider of an interview request submitted by the first user.

In an aspect, the historical database generation method includes a step of storing and generating, by the processor, the historical data set in a plurality of formats comprising an audio format, a video format, and a textual format.

Another aspect of the present disclosure relates to a non-transitory computer-readable storage medium in a distributed computing system, the non-transitory computer-readable storage medium having instructions stored thereupon which, when executed by a processor, cause the processor to transmit, to a second computing device, localization information associated with a first computing device of a first user. The processor is configured to receive, from the second computing device, based on a historical data set, a historic fact associated with the localization information. The processor is configured to generate, by the second computing device, output data on the first computing device. The output data is correlated with the historical data set and the localization information. The output data is associated with the historic fact. The processor is configured to generate, by the second computing device, a request for the first user to add a user-supplied historic fact. The processor is configured to transmit, by the first computing device, the user-supplied historic fact to the second computing device. The user-supplied historic fact is updated to a historical database.

In an aspect, the processor is configured to determine, based on the localization information of the first computing device, a history provider localized within a threshold distance from the first computing device.

In an aspect, the processor is configured to determine, based on a questionnaire comprising one or more preferences of the history provider, that the history provider provides one or more scheduled interviews.

In an aspect, the processor is configured to transmit, to the first computing device, information associated with the history provider and a scheduling request link configured to notify the history provider of an interview request submitted by the first user.

In an aspect, the processor is configured to store and generate the historical data set in a plurality of formats comprising an audio format, a video format, and a textual format.

In an aspect, the first computing device comprises a Global Positioning System (GPS) mechanism to provide the localization information of the first user.

In an aspect, the second computing device is a cloud-based server.

In an aspect, the processor is configured to facilitate the history provider to create a questionnaire related to the historical data set. The cloud-based server is configured to store the questionnaire.

In an aspect, the processor is configured to facilitate the first user to select a year to retrieve the historic fact for that year.

Accordingly, one advantage of the present invention is that it promotes cultural and historical education to enhance the travel experience and foster greater understanding and appreciation between cultures.

Other embodiments and advantages will become readily apparent to those skilled in the art upon viewing the drawings and reading the detailed description hereafter, all without departing from the scope of the disclosure. The drawings and detailed descriptions presented are to be regarded as illustrative in nature and not in any way as restrictive.

Other features of the example embodiments will be apparent from the drawings and from the detailed description that follows.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 is a block diagram that illustrates a system environment in which various embodiments of the historical database generation method and the system may be implemented.

FIG. 2 is a block diagram that illustrates an application server configured to generate historical data based on a geographical location of a first computing device of a first user, in accordance with at least one embodiment.

FIG. 3 illustrates a perspective view of the secondary computing devices of the history providers transmitting historical data to the first computing device of the first user via the application server, in accordance with at least one embodiment.

FIG. 4 is a flowchart that illustrates a method for generating historical data based on a geographical location of a first computing device of a first user, in accordance with at least one embodiment.

### DETAILED DESCRIPTION

The disclosure will be described more fully hereinafter with reference to the accompanying drawings, in which example embodiments of the disclosure are shown, and not intended to be limiting.

Aspects of the present disclosure relate to a historical database generation system that enables users such as tourists and travelers to gather information about the historic events associated with the places they visit, including information about historical UFO sightings, unsolved mysteries, or any other paranormal activity. One objective of the present historical database generation system is to provide users with a way to learn more about the history of the places they visit, including events that may be of interest to those interested in paranormal or unexplained phenomena. For example, if someone visits a town or city known for historical UFO sightings, the system could provide information about those sightings, including the dates and locations of the sightings, as well as any available photos or videos.

Similarly, if someone visits a location known for unsolved mysteries or paranormal activity, such as a haunted house or a location associated with a ghost story, the system could provide information about the history of those events, including any documented sightings or experiences.

The historical database generation system may use a variety of sources to gather information about historical events, including historical records, eyewitness accounts, and media reports. The information could be presented to users in a variety of formats, including text, images, and videos, and could be accessed through a mobile application or website.

In addition, systems, methods, and software disclosed herein may enhance the user's experience of visiting a new place by providing them with a deeper understanding of its history and cultural significance, including any paranormal or unexplained events that have occurred there.

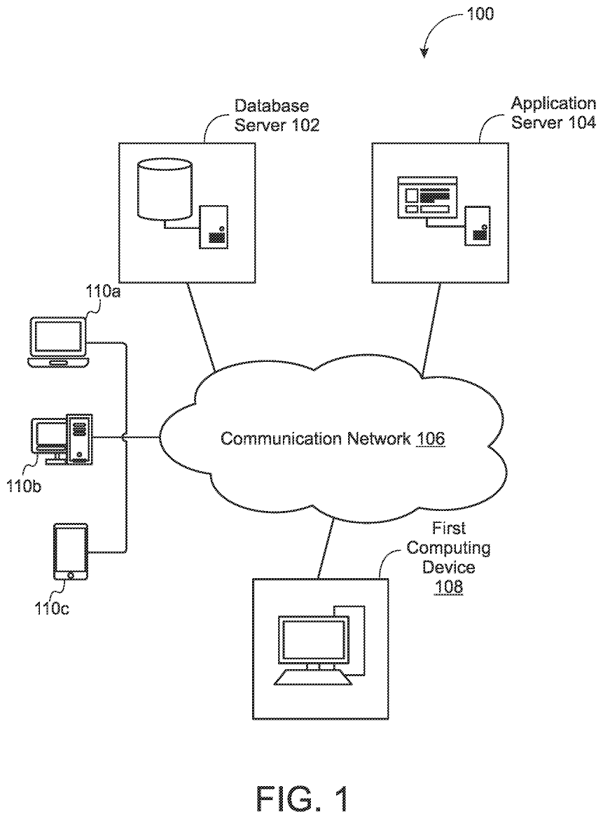

FIG. 1 is a block diagram that illustrates a system environment 100 in which various embodiments of the historical database generation method and the system may be implemented. The system environment 100 may include a database server 102, an application server 104, a communication network 106, a first computing device 108 that may be associated with a first user, and one or more second computing devices 110a, 110b, and 110c collectively referred to with the one or more second computing device 110 that may be associated with one or more second users. In an embodiment, the first user is the user that uses a mobile application or website related to the present historical database generation system to gather information about any place, wherein the mobile application is installed in the first computing device 108. In an embodiment, the first computing device 108 comprises a Global Positioning System (GPS) mechanism to provide the localization information of the first user. In an embodiment, the mobile application is executable on the first computing device 108 of the first user and implemented on one or more operating systems such as Android®, iOS®, Windows®, etc. In an embodiment, the mobile application is commercialized as an application for providing historical data of the specific geographical location. Examples of the first user may include but are not limited to a tourist, a traveler, a backpacker, etc.

In an embodiment, the second users are local residents or a history provider of that particular place about which the first user wants to gather information. The second user uses the second computing device 110 to provide information about the historical events that occur at that particular place or due to which that particular place is famous. The database server 102, the application server 104, the first computing device 108, and the second computing device 110 may be communicatively coupled with each other via the communication network 106. In an embodiment, the application server 104 may communicate with the database server 102 using one or more protocols such as, but not limited to, Open Database Connectivity (ODBC) protocol and Java Database Connectivity (JDBC) protocol. In an embodiment, the first computing device 108, and the one or more second computing devices 110 may communicate with the application server 104, via the communication network 106. Examples of the first computing device 108, and the one or more second computing devices 110 108 may include but are not limited to, a personal computer, a laptop, a personal digital assistant (PDA), a mobile device, a tablet, or any other computing device.

In an embodiment, the database server 102 may refer to a computing device that may be configured to store audio, video, or textual information associated with interesting historic facts via crowdsourcing. In an embodiment, the database server 102 may include a special-purpose operating system specifically configured to perform one or more database operations on important and interesting content related to the history of any particular place. Examples of database operations may include, but are not limited to, Select, Insert, Update, and Delete. In an embodiment, the database server 102 may include hardware that may be configured to perform one or more predetermined operations. In an embodiment, the database server 102 may be realized through various technologies such as, but not limited to, Microsoft® SQL Server, Oracle®, IBM DB2®, Microsoft Access®, PostgreSQL®, MySQL® and SQLite®, and the like.

The database server 102 may be configured to transmit the historical data to the application server 104 for data processing, via the communication network 106. In an embodiment, the database server 102 may be configured to transmit the historical data and content to one or more first computing devices at one or more locations for showcasing the historical data.

A person with ordinary skills in the art will understand that the scope of the disclosure is not limited to the database server 102 as a separate entity. In an embodiment, the functionalities of the database server 102 can be integrated into the application server 104.

In an embodiment, the application server 104 may refer to a computing device or a software framework hosting an application or a software service. In an embodiment, the application server 104 may be implemented to execute procedures such as, but not limited to, programs, routines, or scripts stored in one or more memories for supporting the hosted application or the software service. In an embodiment, the hosted application or the software service may be configured to perform one or more predetermined operations. The application server 104 may be realized through various types of application servers such as, but are not limited to, a Java application server, a .NET framework application server, a Base4 application server, a PHP framework application server, or any other application server framework.

In an embodiment, the application server 104 may be configured to receive localization information associated with a first computing device indicative of a location of a first user. The application server 104 may be configured to receive a historical data set. In an embodiment, the application server 104 may receive information associated with interesting historic facts from publicly available sources and various history providers. The application server 104 may be configured to correlate the localization information of the first user with the historical data set to generate an output data, wherein the output data is associated with the historic fact. The application server 104 may be configured to transmit the historic fact to the first computing device. The application server 104 may be configured to receive, by a second computing device, a user-supplied historic fact from the first user. The application server 104 may be configured to update the user-supplied historic fact in a historical database.

A person having ordinary skill in the art will appreciate that the scope of the disclosure is not limited to realizing the application server 104, the first computing device 108. and the secondary computing devices 110 as separate entities. In an embodiment, the application server 104 may be realized as an application program installed on and/or running on the first computing device 108, and one or more secondary computing devices 110 without departing from the scope of the disclosure.

In an embodiment, the communication network 106 may correspond to a communication medium through which the database server 102, the application server 104, the first computing device 108, and one or more secondary computing devices 110 may communicate with each other. Such communication may be performed, in accordance with various wired and wireless communication protocols. Examples of such wired and wireless communication protocols include, but are not limited to, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, 2G, 3G, 4G cellular communication protocols, and/or Bluetooth (BT) communication protocols. The communication network 106 may include but is not limited to, the Internet, a cloud network, a Wireless Fidelity (Wi-Fi) network, a Wireless Local Area Network (WLAN), a Local Area Network (LAN), a telephone line (POTS), and/or a Metropolitan Area Network (MAN).

In an embodiment, the first computing device 108, and one or more secondary computing devices 110 may comprise of one or more processors and one or more memories. The one or more memories may include computer-readable code that may be executable by one or more processors to perform predetermined operations. In an embodiment, the first computing device 108, and one or more secondary computing devices 110 may present a user interface, received from the application server 104, to the one or more users to display the historical content and insightful data on a display screen of the first computing device 108 associated with the first user.

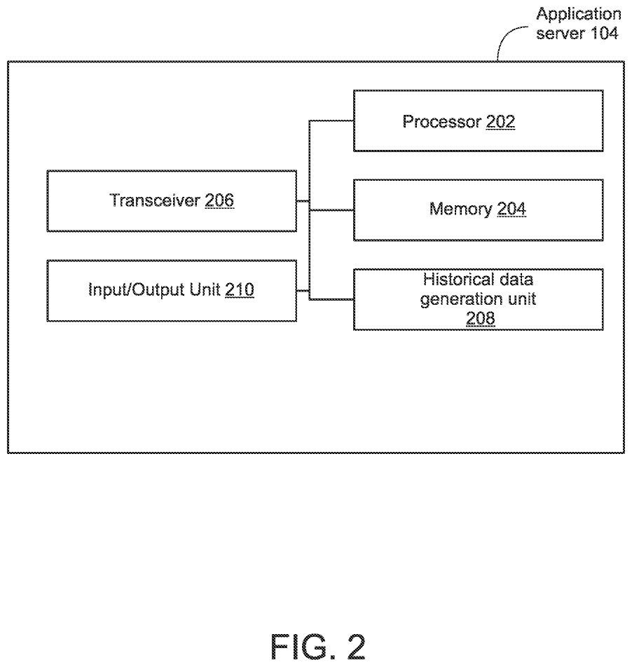

FIG. 2 is a block diagram that illustrates an application server 104 configured to generate historical data based on a geographical location of a first computing device of a first user, in accordance with at least one embodiment. FIG. 2 is explained in conjunction with elements from FIG. 1. In an embodiment, the application server 104 includes a processor 202, a memory 204, a transceiver 206, a historical data generation unit 208, and an input/output unit 210. The processor 202 may be communicatively coupled to the memory 204, the transceiver 206, the historical data generation unit 208, and the input/output unit 210. The transceiver 206 may be communicatively coupled to the communication network 106.

The processor 202 comprises suitable logic, circuitry, interfaces, and/or code that may be configured to execute a set of instructions stored in the memory 204. The processor 202 may be implemented based on several processor technologies known in the art. The processor 202 works in coordination with the transceiver 206, the historical data generation unit 208, and the input/output unit 210 to receive, store, manage and process historical data and facts. Examples of the processor 202 include but are not limited to, an X86-based processor, a Reduced Instruction Set Computing (RISC) processor, an Application-Specific Integrated Circuit (ASIC) processor, a Complex Instruction Set Computing (CISC) processor, and/or other processors.

In an embodiment, the processor 202 is configured to determine, based on the localization information of the first computing device, a history provider localized within a threshold distance from the first computing device. For example, the processor 202 determines which history provider is nearby the first computing device by using its location information, as long as it's within a certain distance. The history provider may also set privacy conditions for the respective account to share the information with the first user (or other users). The processor 202 is configured to determine, based on a questionnaire comprising one or more preferences of the history provider, that the history provider provides one or more scheduled interviews. In an embodiment, the questionnaire includes various FAQs such as when this event happened, what happened, etc. In an embodiment, the history provider creates and stores the questionnaire related to the history of a geographical location in the database server 102. The history provider designs the questionnaire and the type of questions the first user may ask. The history provider includes clear instructions and questions that are easy to understand. The processor 202 is configured to transmit, to the first computing device, information associated with the history provider, and a scheduling request link is configured to notify the history provider of an interview request submitted by the first user. The processor 202 is configured to store and generate the historical data set in a plurality of formats comprising an audio format, a video format, and a textual format.

Thus, the processor 202 is configured to book a face-to-face appointment between the first user and the second user. The processor 202 is configured to determine the second user's availability, and fee for meeting with the first user, and may book the appointment. In an embodiment, the processor 202 is configured to perform financial transactions from a first user account to a second user account when the appointment may be booked.

The memory 204 comprises suitable logic, circuitry, interfaces, and/or code that may be configured to store the set of instructions, which are executed by the processor 202. In an embodiment, the memory 204 may be configured to store one or more programs, routines, or scripts that are executed in coordination with the processor 202. The memory 204 may be implemented based on a Random-Access Memory (RAM), a Read-Only Memory (ROM), a Hard Disk Drive (HDD), a storage server, and/or a Secure Digital (SD) card.

The transceiver 206 comprises suitable logic, circuitry, interfaces, and/or code that may be configured to receive the historical data and localization information from the database server 102, via the communication network 106. The transceiver 206 may be further configured to transmit the historical data and localization information to one or more display screens of the first computing device 108, via the communication network 106. The transceiver 206 may implement one or more known technologies to support wired or wireless communication with the communication network 106. In an embodiment, the transceiver 206 may include, but is not limited to, an antenna, a radio frequency (RF) transceiver, one or more amplifiers, a tuner, one or more oscillators, a digital signal processor, a Universal Serial Bus (USB) device, a coder-decoder (CODEC) chipset, a subscriber identity module (SIM) card, and/or a local buffer. The transceiver 206 may communicate via wireless communication with networks, such as the Internet, an Intranet, and/or a wireless network, such as a cellular telephone network, a wireless local area network (LAN), and/or a metropolitan area network (MAN). The wireless communication may use any of a plurality of communication standards, protocols, and technologies, such as: Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VOIP), Wi-MAX, a protocol for email, instant messaging, and/or Short Message Service (SMS).

The historical data generation unit 208 comprises suitable logic, circuitry, interfaces, and/or code that may be configured to generate historical data, interesting insights, and key events that happened in the specific geographical location.

The input/output unit 210 comprises suitable logic, circuitry, interfaces, and/or code that may be configured to provide one or more inputs to the application server 104 during the generation and transmission of historical data, The input/output unit 210 comprises various input and output devices that are configured to communicate with the processor 202. Examples of the input devices include, but are not limited to, a keyboard, a mouse, a touch screen, a microphone, a camera, and/or a docking station. Examples of the output devices include, but are not limited to, a display screen and/or a speaker.

A person skilled in the art will understand that the scope of the disclosure should not be limited to the generation, transmission, and processing of historical data based on the aforementioned factors and using the aforementioned techniques. Further, the examples provided in the specification are for illustrative purposes and should not be construed to limit the scope of the disclosure.

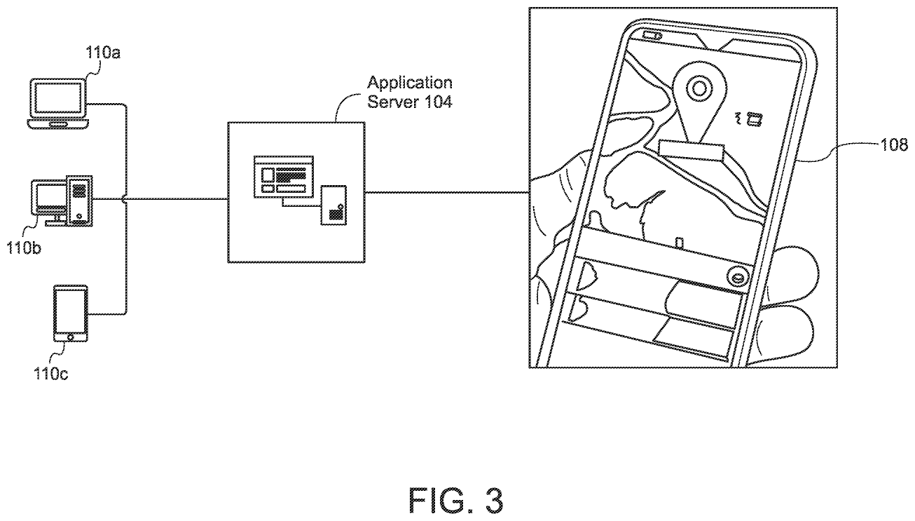

FIG. 3 illustrates a perspective view of the secondary computing devices 110 of the history providers transmit historical data to the first computing device 108 of the first user via the application server 104, in accordance with at least one embodiment. FIG. 3 is explained in conjunction with FIG. 1 and FIG. 2. In an embodiment, a GPS-enabled device (such as a first computing device 108) that comprises software to detect the first user's location. The application server 104 of the present invention then presents the first user with the historical information and events based on the detected location. The historical information and events supplied and created by the local residents or tourist guides through their secondary computing devices 110.

In implementation, a mobile application is developed and installed in the GPS-enabled device to detect the first user's location. The database server 102 stores and integrates a database that contains historical information and events for each geographical location. Then a user interface on the first computing device 108 is created that displays the historical information and events based on the first user's current location. Then the application server 102 allows local residents or tourist guides to contribute to the database by creating and uploading new historical information and events.

In one embodiment, a search function is provided that allows first users to search for specific events or historical information. The mobile application may be further configured to provide interesting and historic facts/information based on years. The first user may select a year to know the interesting and historic facts/information for that year. In some aspects, the mobile application may provide interesting and historic facts and information based on first user preferences, or the first user may select the types of historical facts that the first user may be interested in receiving from the application server 104.

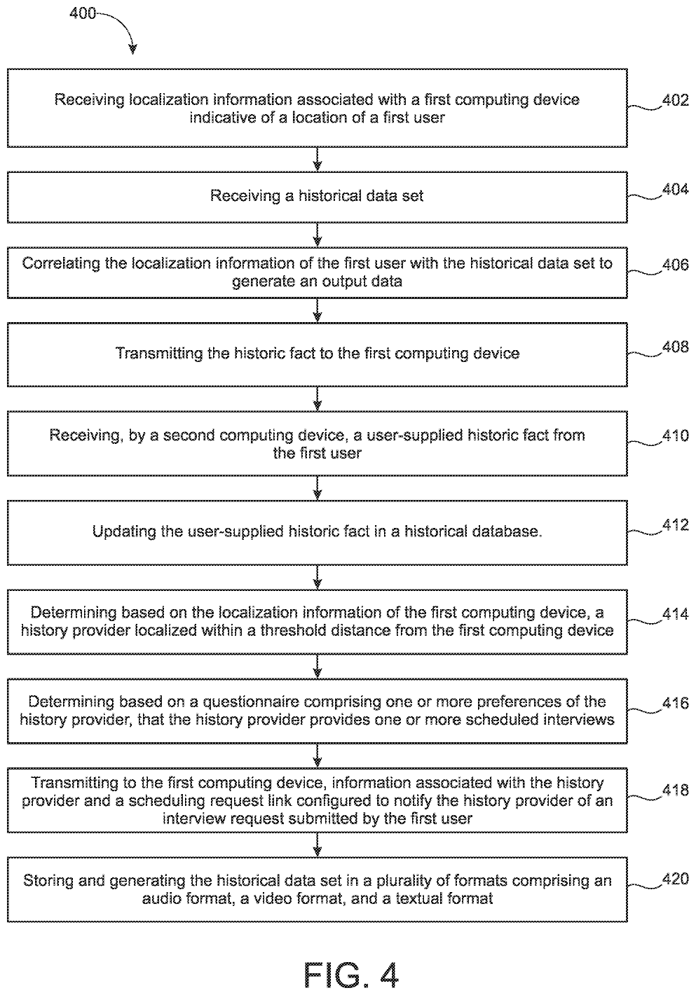

FIG. 4 is a flowchart 400 that illustrates a method for generating historical data based on a geographical location of a first computing device of a first user, in accordance with at least one embodiment. The method initiates with a step 402 of receiving, by a processor, localization information associated with a first computing device indicative of a location of a first user. The method includes a step 404 of receiving, by the processor, a historical data set. The method includes a step 406 of correlating, by the processor, the localization information of the first user with the historical data set to generate output data. The output data is associated with the historic fact. The method includes a step 408 of transmitting, by the processor, the historic fact to the first computing device. The method includes a step 410 of receiving, by a second computing device, a user-supplied historic fact from the first user. The method includes a step 412 of updating, by the processor, the user-supplied historic fact in a historical database. In an embodiment, the historical database generation method includes a step 414 of determining, by the processor, based on the localization information of the first computing device, a history provider localized within a threshold distance from the first computing device. In an embodiment, the historical database generation method includes a step 416 of determining, by the processor, based on a questionnaire comprising one or more preferences of the history provider, that the history provider provides one or more scheduled interviews. In an embodiment, the historical database generation method includes a step 418 of transmitting, by the processor, to the first computing device, information associated with the history provider, and a scheduling request link configured to notify the history provider of an interview request submitted by the first user. In an embodiment, the historical database generation method includes a step 420 of storing and generating, by the processor, the historical data set in a plurality of formats comprising an audio format, a video format, and a textual format.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A historical database generation system comprising:
a processor; and
a memory communicatively coupled to the processor, wherein the memory stores a plurality of instructions, which, on execution, causes the processor to:
transmit, to a second computing device, localization information associated with a first computing device of a first user;
receive, from the second computing device, based on a historical data set, a historic fact associated with the localization information;
generate, by the second computing device, an output data on the first computing device, wherein the output data is correlated with the historical data set and the localization information, wherein the output data is associated with the historic fact;
generate, by the second computing device, a request for the first user to add a user-supplied historic fact; and
transmit, by the first computing device, the user-supplied historic fact to the second computing device, wherein the user-supplied historic fact is updated to a historical database.

2. The system according to claim 1, wherein the processor is configured to:
determine, based on the localization information of the first computing device, a history provider localized within a threshold distance from the first computing device;
determine, based on a questionnaire comprising one or more preferences of the history provider, that the history provider provides one or more scheduled interviews; and
transmit, to the first computing device, information associated with the history provider and a scheduling request link configured to notify the history provider of an interview request submitted by the first user.

3. The system according to claim 1, wherein the processor is configured to store and generate the historical data set in a plurality of formats comprising an audio format, a video format, and a textual format.

4. The system according to claim 1, wherein the first computing device comprises a Global Positioning System (GPS) mechanism to provide the localization information of the first user.

5. The system according to claim 1, wherein the second computing device is a cloud-based server.

6. The system according to claim 1, wherein the processor is configured to facilitate the history provider to create a questionnaire related to the historical data set, wherein the cloud-based server is configured to store the questionnaire.

7. The system according to claim 1, wherein the processor is configured to facilitate the first user to select a year to retrieve the historic fact for that year.

8. An application server comprising:
a processor; and
a memory communicatively coupled to the processor, wherein the memory stores processor instructions, which, on execution, causes the processor to:
receive localization information associated with a first computing device indicative of a location of a first user;
receive a historical data set;
correlate the localization information of the first user with the historical data set to generate an output data, wherein the output data is associated with a historic fact;
transmit the historic fact to the first computing device;
receive, by a second computing device, a user-supplied historic fact from the first user; and
update the user-supplied historic fact in a historical database.

9. The application server according to claim 8, wherein the processor is further configured to:
determine, based on the localization information of the first computing device, a history provider localized within a threshold distance from the first computing device;
determine, based on a questionnaire comprising one or more preferences of the history provider, that the history provider provides one or more scheduled interviews; and
transmit, to the first computing device, information associated with the history provider and a scheduling request link configured to notify the history provider of an interview request submitted by the first user.

10. The application server according to claim 8, wherein the processor is configured to store and generate the historical data set in a plurality of formats comprising an audio format, a video format, and a textual format.

11. The application server according to claim 8, wherein the first computing device comprises a Global Positioning System (GPS) mechanism to provide the localization information of the first user.

12. A historical database generation method comprising:
receiving, by a processor, localization information associated with a first computing device indicative of a location of a first user;
receiving, by the processor, a historical data set;
correlating, by the processor, the localization information of the first user with the historical data set to generate an output data, wherein the output data is associated with a historic fact;
transmitting, by the processor, the historic fact to the first computing device;
receiving, by a second computing device, a user-supplied historic fact from the first user; and
updating, by the processor, the user-supplied historic fact in a historical database.

13. The historical database generation method according to claim 12 comprises steps of:
determining, by the processor, based on the localization information of the first computing device, a history provider localized within a threshold distance from the first computing device;
determining, by the processor, based on a questionnaire comprising one or more preferences of the history provider, that the history provider provides one or more scheduled interviews; and
transmitting, by the processor, to the first computing device, information associated with the history provider and a scheduling request link configured to notify the history provider of an interview request submitted by the first user.

14. The historical database generation method according to claim 12 comprises a step of: storing and generating, by the processor, the historical data set in a plurality of formats comprising an audio format, a video format, and a textual format.

15. A non-transitory computer-readable storage medium in a distributed computing system, the non-transitory computer-readable storage medium having instructions stored thereupon which, when executed by a processor, cause the processor to:
transmit, to a second computing device, localization information associated with a first computing device of a first user;
receive, from the second computing device, based on a historical data set, a historic fact associated with the localization information;
generate, by the second computing device, an output data on the first computing device, wherein the output data is correlated with the historical data set and the localization information, wherein the output data is associated with the historic fact;
generate, by the second computing device, a request for the first user to add a user-supplied historic fact; and
transmit, by the first computing device, the user-supplied historic fact to the second computing device, wherein the user-supplied historic fact is updated to a historical database.

16. The non-transitory computer-readable storage medium according to claim 15, wherein the processor is configured to:
determine, based on the localization information of the first computing device, a history provider localized within a threshold distance from the first computing device;
determine, based on a questionnaire comprising one or more preferences of the history provider, that the history provider provides one or more scheduled interviews; and
transmit, to the first computing device, information associated with the history provider and a scheduling request link configured to notify the history provider of an interview request submitted by the first user.

17. The non-transitory computer-readable storage medium according to claim 15, wherein the processor is configured to store and generate the historical data set in a plurality of formats comprising an audio format, a video format, and a textual format.

18. The non-transitory computer-readable storage medium according to claim 15, wherein the first computing device comprises a Global Positioning System (GPS) mechanism to provide the localization information of the first user.

19. The non-transitory computer-readable storage medium according to claim 15, wherein the second computing device is a cloud-based server.

20. The non-transitory computer-readable storage medium according to claim 15, wherein the processor is configured to facilitate a history provider to create a questionnaire related to the historical data set, wherein the cloud-based server is configured to store the questionnaire.
